(19) United States
(12) Patent Application Publication
(10) Pub. No.: US 2024/0267559 A1
(43) Pub. Date: Aug. 8, 2024

(54) INFORMATION PROCESSING APPARATUS AND INFORMATION PROCESSING METHOD

(71) Applicant: SONY GROUP CORPORATION, TOKYO (JP)

(72) Inventor: TOSHIYA HAMADA, TOKYO (JP)

(21) Appl. No.: 18/563,097

(22) PCT Filed: Feb. 21, 2022
(86) PCT No.: PCT/JP2022/006877

§ 371 Date: Nov. 21, 2023

(30) Foreign Application Priority Data
Jun. 10, 2021 (JP) 2021-097337

(51) Int. Cl. H04N 19/597; H04N 19/119; H04N 19/124; H04N 19/154; H04N 19/167; H04N 19/30

(52) U.S. Cl. CPC H04N 19/597; H04N 19/119; H04N 19/124; H04N 19/154; H04N 19/167; H04N 19/30

(57) ABSTRACT

An information processing apparatus includes a rendering section and an encoding section. The rendering section performs rendering processing on three-dimensional space data on the basis of field-of-view information regarding a field of view of a user to generate two-dimensional video data depending on the field of view of the user. The encoding section calculates, as evaluation values, values of SSIM or values of VMAF for respective division regions of a plurality of division regions obtained by dividing a display region in which the generated two-dimensional video data is displayed, each evaluation value being obtained by numerically expressing a degradation in image quality that is caused due to encoding; sets quantization parameters for the respective division regions of the plurality of division regions such that the evaluation values for the respective division regions of the plurality of division regions are equal; and performs encoding processing on the two-dimensional video data on the basis of the set quantization parameters.

### TECHNICAL FIELD

The present technology relates to an information processing apparatus and an information processing method that can be applied to, for example, the distribution of virtual-reality (VR) videos.

### BACKGROUND ART

In recent years, 360-degree-all-direction videos captured by, for example, 360-degree-all-direction cameras and viewed in all directions, have been increasingly distributed. Further, recently, a technology used to distribute six-degrees-of-freedom (DoF) videos (also referred to as 6-DoF content) that enable viewers (users) to view in all directions (to freely select a direction of a line of sight), and to freely move in a three-dimensional space (to freely select a position of a viewpoint) has been under development.

In such 6-DoF content, a three-dimensional space with at least one three-dimensional object is dynamically reproduced for each time according to a position of a viewpoint of a viewer, a direction of a line of sight of the viewer, and a viewing angle (a field of view) of the viewer.

In such video distribution, there is a need to dynamically adjust (render), according to a field of view of a viewer, video data to be provided to the viewer. For example, the technology disclosed in Patent Literature 1 is an example of such a technology.

Non-Patent Literature 1 discloses structural similarity (SSIM) used as an indicator used to assess the image quality after encoding.

Likewise, Non-Patent Literature 2 discloses Video Multimethod Assessment Fusion (VMAF) used as an indicator used to assess the image quality after encoding.

### CITATION LIST

### Patent Literature

Patent Literature 1: Japanese Unexamined Patent Application Publication No. 2007-520925

### Non-Patent Literature

Non-Patent Literature 1: Zhou Wang, et al., “The SSIM Index for Image Quality Assessment”, [online], February, 2023, Zhou Wang's Homepage, Internet <URL: https://ece.uwaterloo.ca/˜z70wang/research/ssim/>

Non-Patent Literature 2: Netflix/vmaf, [online], Internet <URL: https://github.com/Netflix/vmaf>

### DISCLOSURE OF INVENTION

### Technical Problem

The distribution of virtual videos such as VR videos is expected to become more prevailing, and thus there is a need for a technology that makes it possible to distribute high-quality virtual videos.

In view of the circumstances described above, it is an object of the present technology to provide an information processing apparatus and an information processing method that make it possible to distribute high-quality virtual videos.

### Solution to Problem

In order to achieve the object described above, an information processing apparatus according to an embodiment of the present technology includes a rendering section and an encoding section.

The rendering section performs rendering processing on three-dimensional space data on the basis of field-of-view information regarding a field of view of a user to generate two-dimensional video data depending on the field of view of the user.

The encoding section
calculates, as evaluation values, values of structural similarity (SSIM) or values of Video Multimethod Assessment Fusion (VMAF) for respective division regions of a plurality of division regions obtained by dividing a display region in which the generated two-dimensional video data is displayed, each evaluation value being obtained by numerically expressing a degradation in image quality that is caused due to encoding,
sets quantization parameters for the respective division regions of the plurality of division regions such that the evaluation values for the respective division regions of the plurality of division regions are equal, and
performs encoding processing on the two-dimensional video data on the basis of the set quantization parameters.

In the information processing apparatus, values of SSIM or VMAF are calculated as evaluation values for respective division regions of a plurality of division regions obtained by dividing the display region. Further, quantization parameters are set for the respective division regions of the plurality of division regions such that the evaluation values for the respective division regions of the plurality of division regions are equal. This makes it possible to distribute high-quality virtual videos.

The encoding section may calculate a difference between a maximum value and a minimum value of the evaluation values for the respective division regions of the plurality of division regions, and may set the quantization parameters for the respective division regions of the plurality of division regions such that the difference is less than a specified threshold.

The encoding section may decrease the quantization parameter for the division region that is included in the plurality of division regions and for which the evaluation value is to be increased, and may increase the quantization parameter for the division region that is included in the plurality of division regions and for which the evaluation value is to be decreased.

The rendering section may generate the two-dimensional video data such that a resolution of the two-dimensional video data is nonuniform in the display region in which the two-dimensional video data is displayed. In this case, the encoding section may divide the generated two-dimensional video data into the division regions of the plurality of division regions on the basis of a distribution of the resolution of the generated two-dimensional video data.

The rendering section may set a region of interest and a region of non-interest in the display region in which the two-dimensional video data is displayed, the region of interest being to be rendered at a high resolution, the region of non-interest being to be rendered at a low resolution; may render the region of interest at a high resolution; and may render the region of non-interest at a low resolution.

In this case, the encoding section may set a high-resolution region and a low-resolution region in the display region as the plurality of division regions on the basis of respective positions of the region of interest and the region of non-interest in the display region, may calculate the respective evaluation values for the high-resolution region and the low-resolution region, and may set the respective quantization parameters for the high-resolution region and the low-resolution region such that the respective evaluation values for the high-resolution region and the low-resolution region are equal.

The encoding section may set, for the high-resolution region, a first quantization parameter to a fixed value, and may set a value of a second quantization parameter for the low-resolution region such that the evaluation value for the low-resolution region is equal to the evaluation value for the high-resolution region.

The encoding section may set the value of the second quantization parameter for the low-resolution region such that a difference between the evaluation value for the low-resolution region and the evaluation value for the high-resolution region is less than a specified threshold.

The high-resolution region may be the same as the region of interest. In this case, the low-resolution region may be the same as the region of non-interest.

The second quantization parameter may be greater than the first quantization parameter.

The rendering section may set the region of interest and the region of non-interest on the basis of the field-of-view information.

The three-dimensional space data may include at least one of 360-degree-all-direction video data or space video data.

An information processing method according to an embodiment of the present technology is an information processing method that is performed by a computer system, the information processing method including performing rendering processing on three-dimensional space data on the basis of field-of-view information regarding a field of view of a user to generate two-dimensional video data depending on the field of view of the user.

Values of structural similarity (SSIM) are calculated as evaluation values for respective division regions of a plurality of division regions obtained by dividing a display region in which the generated two-dimensional video data is displayed, each evaluation value being obtained by numerically expressing a degradation in image quality that is caused due to encoding.

Quantization parameters are set for the respective division regions of the plurality of division regions such that the evaluation values for the respective division regions of the plurality of division regions are equal.

Encoding processing is performed on the two-dimensional video data on the basis of the set quantization parameters.

An information processing method according to another embodiment of the present technology is an information processing method that is performed by a computer system, the information processing method including performing rendering processing on three-dimensional space data on the basis of field-of-view information regarding a field of view of a user to generate two-dimensional video data depending on the field of view of the user.

Values of Video Multimethod Assessment Fusion (VMAF) are calculated as evaluation values for respective division regions of a plurality of division regions obtained by dividing a display region in which the generated two-dimensional video data is displayed, each evaluation value being obtained by numerically expressing a degradation in image quality that is caused due to encoding.

Quantization parameters are set for the respective division regions of the plurality of division regions such that the evaluation values for the respective division regions of the plurality of division regions are equal.

Encoding processing is performed on the two-dimensional video data on the basis of the set quantization parameters.

### BRIEF DESCRIPTION OF DRAWINGS

FIG. 1 schematically illustrates an example of a basic configuration of a server-side rendering system.

FIG. 2 is a schematic diagram used to describe an example of a virtual video that can be viewed by a user.

FIG. 3 is a schematic diagram used to describe rendering processing.

FIG. 4 schematically illustrates an example of a functional configuration of the server-side rendering system.

FIG. 5 schematically illustrates a specific example of configurations of a rendering section and an encoding section that are illustrated in FIG. 4.

FIG. 6 is a flowchart illustrating an example of processing of cooperation between a renderer and an encoder.

FIG. 7 is a schematic diagram used to describe an example of foveated rendering.

FIG. 8 is a flowchart illustrating an example of generating a nonuniform QP map.

FIG. 9 is a schematic diagram used to describe processing of the generation illustrated in FIG. 8.

FIG. 10 is a flowchart illustrating an example of determining QP values for respective division regions of a plurality of division regions.

FIG. 11 is a schematic diagram used to describe another method for setting a plurality of division regions.

FIG. 12 is a graph in which a value of SSIM for a second QP value with respect to a low-resolution region is given.

FIG. 13 is a block diagram illustrating an example of a hardware configuration of a computer (an information processing apparatus) by which a server apparatus and a client apparatus can be implemented.

### MODE(S) FOR CARRYING OUT THE INVENTION

Embodiments according to the present technology will now be described below with reference to the drawings.

### Server-Side Rendering System

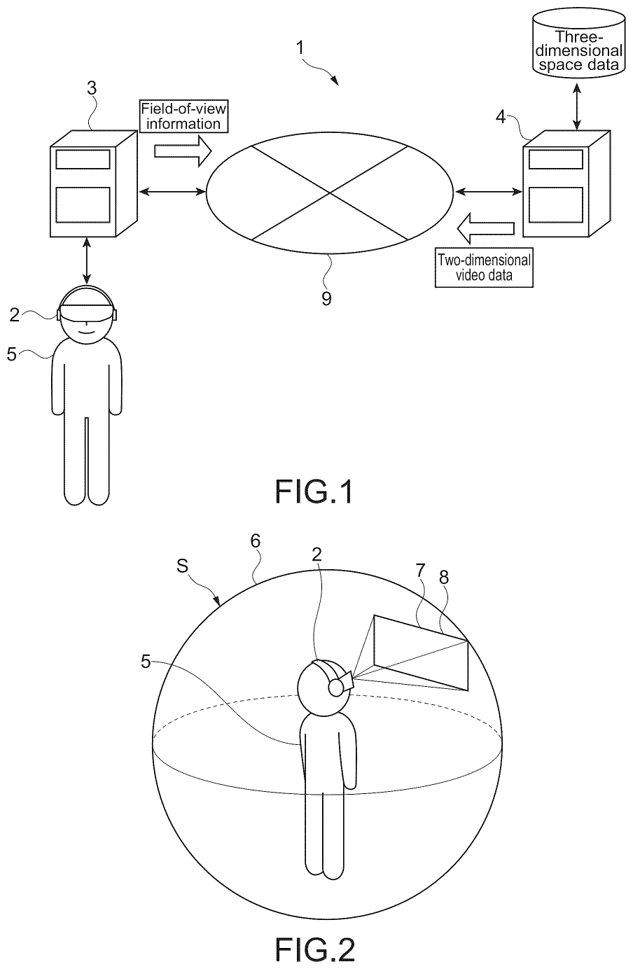

A server-side rendering system is configured as an embodiment according to the present technology. First, an example of a basic configuration and an example of a basic operation of a server-side rendering system is described with reference to FIGS. 1 to 3.

FIG. 1 schematically illustrates an example of the basic configuration of the server-side rendering system.

FIG. 2 is a schematic diagram used to describe an example of a virtual video that can be viewed by a user.

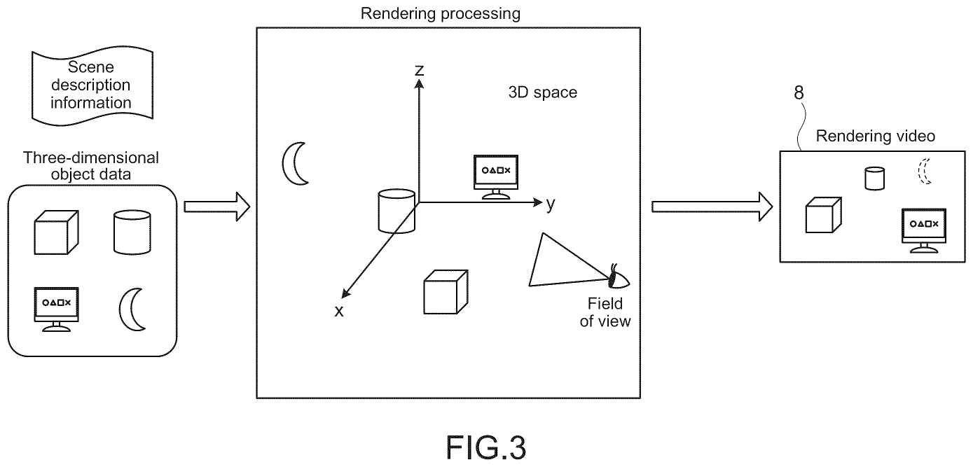

FIG. 3 is a schematic diagram used to describe rendering processing.

Note that the server-side rendering system can also be referred to as a server-rendering media distribution system.

As illustrated in FIG. 1, a server-side rendering system 1 includes a head-mounted display (HMD) 2, a client apparatus 3, and a server apparatus 4.

The HMD 2 is a device used to display a virtual video to a user 5. The HMD 2 is used by being worn on a head of the user 5.

For example, when a VR video is distributed as a virtual video, the HMD 2 of an immersive type, which is configured to cover a field of view of the user 5, is used.

When an augmented reality (AR) video is distributed as a virtual video, AR glasses or the like are used as the HMD 2.

A device other than the HMD 2 may be used as a device used to provide a virtual video to the user 5. For example, a virtual video can be displayed on a display provided to a television, a smartphone, a tablet terminal, or a personal computer (PC).

In the present embodiment, a full 360-degree spherical video 6 is provided as a VR video to the user 5 wearing the immersive HMD 2, as illustrated in FIG. 2. Further, the full 360-degree spherical video 6 is provided to the user 5 as a 6-DoF video.

In a virtual space S that is a three-dimensional space, the user 5 can view a video in a range of 360 degrees in all directions from back and forth, from side to side, and up and down. For example, the user 5 freely moves, for example, a position of his/her viewpoint and a direction of his/her line of sight in the virtual space S to freely change his/her own field of view 7. In response to the change in the field of view 7 of the user 5, videos 8 displayed to the user 5 are switched. The user 5 performs a motion such as turning his/her head, inclining his/her head, or turning, and this enables the user 5 to view a surrounding region in the virtual space S as if the user 5 were in a real world.

As described above, the server-side rendering system 1 according to the present embodiment makes it possible to distribute a free-viewpoint photorealistic video, and to thus provide an experience in viewing at a position of a free viewpoint.

In the present embodiment, the HMD 2 acquires field-of-view information.

The field-of-view information is information regarding the field of view 7 of the user 5. Specifically, the field-of-view information includes any information that makes it possible to specify the field of view 7 of the user 5 in the virtual space S.

Examples of the field-of-view information include a position of a viewpoint, a direction of a line of sight, and an angle of rotation of the line of sight. The examples of the field-of-view information further include a position of a head of the user 5 and an angle of turning of the head of the user 5. The position of a head of a user and the angle of turning of the head of the user can also be referred to as head-motion information.

For example, the angle of rotation of a line of sight can be defined by an angle of rotation about a rotational axis that extends in parallel with the line of sight. Further, the angle of turning of the head of the user 5 can be defined by a roll angle, a pitch angle, and a yaw angle that are obtained when three axes that are set with respect to the head and orthogonal to each other are a roll axis, a pitch axis, and a yaw axis.

For example, an axis that extends in a front direction in which the face faces is defined as a roll axis. An axis that extends in a right-and-left direction when the face of the user 5 is viewed from the front is defined as a pitch axis, and an axis that extends in an up-and-down direction when the face of the user 5 is viewed from the front is defined as a yaw axis. A roll angle, a pitch angle, and a yaw angle that are respectively obtained with respect to the roll axis, the pitch axis, and the yaw axis are calculated as an angle of turning of a head. Note that a direction of the roll axis can also be used as a direction of a line of sight.

Moreover, any information that makes it possible to specify the field of view of the user 5 may be used. One of the pieces of information described above as examples may be used as field-of-view information, or a plurality of the pieces of information may be used in combination as the field-of-view information.

A method for acquiring field-of-view information is not limited. For example, the field-of-view information can be acquired on the basis of a result of detection (a result of sensing) performed by a sensor apparatus (including a camera) that is included in the HMD 2.

For example, the HMD 2 is provided with, for example, a camera or ranging sensor of which a detection range covers a region around the user 5, or inward-oriented cameras that can respectively capture an image of a right eye of the user 5 and an image of a left eye of the user 5. Further, the HMD 2 is provided with an inertial measurement unit (IMU) sensor or a GPS.

For example, position information regarding a position of the HMD 2 that is acquired by a GPS can be used as a position of the viewpoint of the user 5 or a position of the head of the user 5. Of course, positions of the right and left eyes of the user 5, or the like may be calculated in more detail.

Further, a direction of a line of sight can be detected using captured images of the right and left eyes of the user 5.

Furthermore, an angle of rotation of a line of sight and an angle of turning of the head of the user 5 can be detected using a result of detection performed by an IMU.

Further, a self-location of the user 5 (the HMD 2) may be estimated on the basis of a result of detection performed by a sensor apparatus included in the HMD 2. For example, position information regarding a position of the HMD 2 and pose information regarding, for example, which direction the HMD 2 is oriented toward can be calculated by the self-location estimation. Field-of-view information can be acquired using the position information and the pose information.

An algorithm used to estimate a self-location of the HMD 2 is also not limited, and any algorithm such as simultaneous localization and mapping (SLAM) may be used.

Further, head tracking performed to detect a motion of the head of the user 5, or eye tracking performed to detect movement of right and left lines of sight of the user 5 may be performed.

Moreover, any device or any algorithm may be used in order to acquire field-of-view information. For example, when a smartphone or the like is used as a device used to display a virtual video to the user 5, an image of, for example, the face (the head) of the user 5 may be captured, and the field-of-view information may be acquired on the basis of the captured image.

Alternatively, a device that includes, for example, a camera or an IMU may be attached to the head of the user 5 or around the eyes of the user 5.

Any machine-learning algorithm using, for example, a deep neural network (DNN) may be used in order to generate the field-of-view information. The use of, for example, artificial intelligence (AI) performing deep learning makes it possible to improve the accuracy in generating the field-of-view information.

Note that a machine-learning algorithm can be applied to any processing performed in the present disclosure.

The HMD 2 and the client apparatus 3 are connected to be capable of communicating with each other. The type of communication used to connect both of the devices such that the devices are capable of communicating with each other is not limited, and any communication technology may be used. For example, wireless network communication using, for example, Wi-Fi or near field communication using, for example, Bluetooth (registered trademark) can be used.

The HMD 2 transmits the field-of-view information to the client apparatus 3.

Note that the HMD 2 and the client apparatus 3 may be integrated with each other. In other words, the HMD 2 includes a function of the client apparatus 3.

The client apparatus 3 and the server apparatus 4 each include hardware, such as a CPU, a ROM, a RAM, and an HDD, that is necessary for a configuration of a computer (refer to FIG. 13). An information processing method according to the present technology is performed by, for example, the CPU loading, into the RAM, a program according to the present technology that is recorded in, for example, the ROM in advance and executing the program.

For example, the client apparatus 3 and the server apparatus 4 can be implemented by any computers such as personal computers (PC). Of course, hardware such as an FPGA or an ASIC may be used.

Of course, the client apparatus 3 and the server apparatus 4 are not limited to having configurations identical to each other.

The client apparatus 3 and the server apparatus 4 are connected through a network 9 to be capable of communicating with each other.

The network 9 is built by, for example, the Internet or a wide area communication network. Moreover, for example, any wide area network (WAN) or any local area network (LAN) may be used, and a protocol used to build the network 9 is not limited.

The client apparatus 3 receives field-of-view information transmitted by the HMD 2. Further, the client apparatus 3 transmits the field-of-view information to the server apparatus 4 through the network 9.

The server apparatus 4 receives field-of-view information transmitted by the client apparatus 3. Further, on the basis of the field-of-view information, the server apparatus 4 performs rendering processing on three-dimensional space data to generate two-dimensional video data (a rendering video) depending on the field of view 7 of the user 5.

The server apparatus 4 corresponds to an embodiment of an information processing apparatus according to the present technology. An embodiment of the information processing method according to the present technology is performed by the server apparatus 4.

As illustrated in FIG. 3, the three-dimensional space data includes scene description information and three-dimensional object data.

The scene description information corresponds to three-dimensional-space-description data used to define a configuration of a three-dimensional space (the virtual space S). The scene description information includes various metadata, such as attribute information regarding an attribute of an object, that is used to reproduce each scene of 6-DoF content.

The three-dimensional object data is data used to define a three-dimensional object in a three-dimensional space. In other words, the three-dimensional object data is data of an object that forms a scene of 6-DoF content.

For example, data of three-dimensional objects of, for example, humans and animals, and data of three-dimensional objects of, for example, buildings and trees are stored. Alternatively, data of three-dimensional objects of, for example, the sky and the sea, which are included in, for example, a background is stored. A plurality of types of objects may be grouped as one three-dimensional object, and data of the one three-dimensional object may be stored.

The three-dimensional object data includes mesh data that can be represented in the form of polyhedron-shaped data, and texture data that is data attached to a face of the mesh data. Alternatively, the three-dimensional object data includes a collection of a plurality of points (a group of points) (point cloud).

On the basis of scene description information, the server apparatus 4 arranges a three-dimensional object in a three-dimensional space to reproduce the three-dimensional space, as illustrated in FIG. 3. The three-dimensional space is reproduced on a memory by computation being performed.

A video as viewed by the user 5 is captured on the basis of the reproduced three-dimensional space (rendering processing) to generate a rendering video that is a two-dimensional video to be viewed by the user 5.

The server apparatus 4 encodes the generated rendering video, and transmits the encoded rendering video to the client apparatus 3 through the network 9.

Note that a rendering video depending on the field of view 7 of a user can also be a video in a viewport (a display region) depending on the field of view 7 of the user.

The client apparatus 3 decodes the encoded rendering video transmitted by the server apparatus 4. Further, the client apparatus 3 transmits, to the HMD 2, the rendering video obtained by the decoding.

As illustrated in FIG. 2, a rendering video is played to be displayed to the user 5 by the HMD 2. A video 8 that is displayed to the user 5 by the HMD 2 may be hereinafter referred to as a rendering video 8.

### Advantage of Server-Side Rendering System

A client-side rendering system is another example of a system of distributing the full 360-degree spherical video 6 (a 6-DoF video) as illustrated in FIG. 2.

In the client-side rendering system, the client apparatus 3 performs rendering processing on three-dimensional space data on the basis of field-of-view information to generate two-dimensional video data (the rendering video 8). The client-side rendering system can also be referred to as a client-rendering media distribution system.

In the client-side rendering system, it is necessary that the server apparatus 4 transmit three-dimensional space data (three-dimensional-space-description data and three-dimensional object data) to the client apparatus 3.

The three-dimensional object data includes mesh data or group-of-points data (point cloud). Thus, a huge amount of distribution data is transmitted from the server apparatus 4 to the client apparatus 3. Further, it is necessary that the client apparatus 3 have a significantly great processing capability in order to perform rendering processing.

On the other hand, in the server-side rendering system 1 according to the present embodiment, the rendering video 8 after rendering is distributed to the client apparatus 3. This makes it possible to sufficiently reduce the amount of distribution data. In other words, this enables the user 5 to experience, with a smaller amount of distribution data, a 6-DoF video, in a large space, that includes a huge amount of three-dimensional object data.

Further, processing burdens imposed on the client apparatus 3 can be unloaded onto the server apparatus 4. This also enables the user 5 to experience a 6-DoF video when the client apparatus 3 having a low processing capability is used.

Further, there is also a client-side-rendering distribution method including selecting, according to field-of-view information regarding a field of view of a user, an optimal piece of 3D object data from a plurality of pieces of 3D object data (for example, two kinds of pieces of data that are a piece of high-resolution data and a piece of low-resolution data) having different data sizes (qualities) and being provided in advance.

Comparison is performed with this distribution method. When the server-side rendering is applied, switching between pieces of 3D object data of two kinds of qualities is not performed even when there is a change in field of view. Thus, the server-side rendering provides an advantage in that seamless playback can be performed even when there is a change in field of view.

Further, when the client-side rendering is applied, field-of-view information is not transmitted to the server apparatus 4. Thus, it is necessary that the client apparatus 3 perform processing such as blurring on a specified region in the rendering video 8 if needed. In this case, 3D object data before blurring is transmitted to the client apparatus 3. This still results in difficulty in reducing an amount of distribution data.

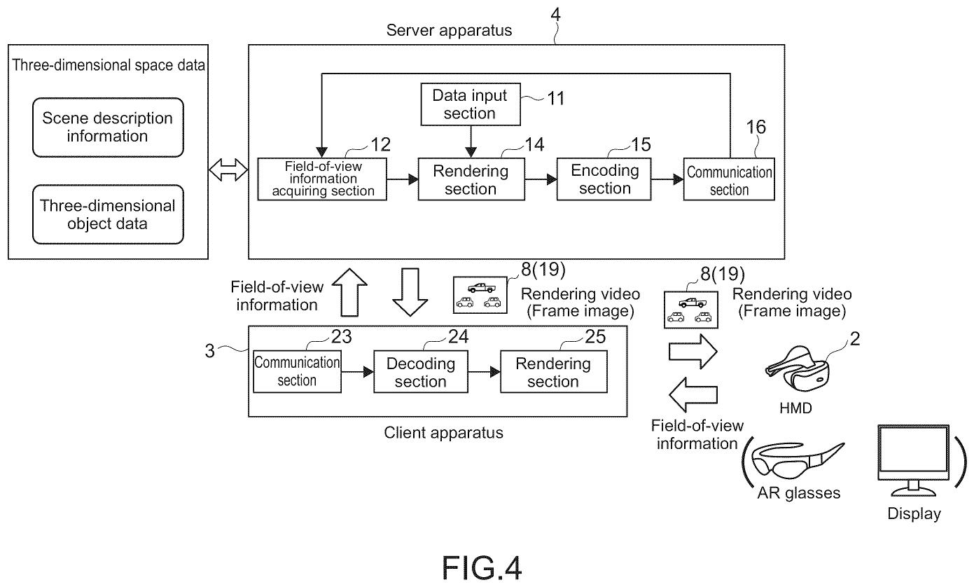

FIG. 4 schematically illustrates an example of a functional configuration of the server-side rendering system 1.

The HMD 2 acquires field-of-view information regarding the field of view of the user 5 in real time.

For example, the HMD 2 acquires the field-of-view information at a specified frame rate, and transmits the acquired field-of-view information to the client apparatus 3. Likewise, the client apparatus 3 transmits the field-of-view information repeatedly to the server apparatus 4 at a specified frame rate.

The frame rate at which field-of-view information is acquired (the number of times that field-of-view information is acquired per second) is set to be, for example, synchronized with a frame rate of the rendering video 8.

For example, the rendering video 8 is formed of a plurality of chronologically subsequent frame images. Each frame image is generated at a specified frame rate. The frame rate at which field-of-view information is acquired is set to be synchronized with the above-described frame rate of the rendering video 8. Of course, the configuration is not limited thereto.

Further, AR glasses or a display may be used as a device used to display a virtual video to the user 5, as described above.

The server apparatus 4 includes a data input section 11, a field-of-view information acquiring section 12, a rendering section 14, an encoding section 15, and a communication section 16.

These functional blocks are implemented by, for example, a CPU executing a program according to the present technology, and the information processing method according to the present embodiment is performed. Note that, in order to implement each functional block, dedicated hardware such as an integrated circuit (IC) may be used as appropriate.

The data input section 11 reads three-dimensional space data (scene description information and three-dimensional object data), and outputs the read three-dimensional space data to the rendering section 14.

Note that the three-dimensional space data is stored in, for example, a storage 68 (refer to FIG. 13) in the server apparatus 4. Alternatively, the three-dimensional space data may be managed by, for example, a content server that is connected to the server apparatus 4 to be capable of communicating with the server apparatus 4. In this case, the data input section 11 accesses the content server to acquire the three-dimensional space data.

The communication section 16 is a module used to perform, for example, network communication or near field communication with another device. For example, a wireless LAN module such as Wi-Fi, or a communication module such as Bluetooth (registered trademark) is provided.

In the present embodiment, communication with the client apparatus 3 through the network 9 is performed by the communication section 16.

The field-of-view information acquiring section 12 acquires field-of-view information from the client apparatus 3 through the communication section 16. The acquired field-of-view information may be recorded in, for example, the storage 68 (refer to FIG. 13). For example, a buffer or the like used to record the field-of-view information may be provided.

The rendering section 14 performs rendering processing, as illustrated in FIG. 3. In other words, rendering processing is performed on three-dimensional space data on the basis of field-of-view information acquired in real time to generate the rendering video 8 depending on the field of view 7 of the user 5.

In the present embodiment, a frame image 19 that forms the rendering video 8 is generated in real time on the basis of field-of-view information acquired at a specified frame rate.

The encoding section 15 performs encoding processing (compression coding) on the rendering video 8 (the frame image 19) to generate distribution data. The distribution data is packetized by the communication section 16 to be transmitted to the client apparatus 3.

This makes it possible to distribute the frame image 19 in real time in response to field-of-view information acquired in real time.

In the present embodiment, the rendering section 14 serves as an embodiment of a rendering section according to the present technology. The encoding section 15 serves as an embodiment of an encoding section according to the present technology.

The client apparatus 3 includes a communication section 23, a decoding section 24, and a rendering section 25.

These functional blocks are implemented by, for example, a CPU executing the program according to the present technology, and the information processing method according to the present embodiment is performed. Note that, in order to implement each functional block, dedicated hardware such as an integrated circuit (IC) may be used as appropriate.

The communication section 23 is a module used to perform, for example, network communication or near field communication with another device. For example, a wireless LAN module such as Wi-Fi, or a communication module such as Bluetooth (registered trademark) is provided.

The decoding section 24 performs decoding processing on distribution data. This results in decoding the encoded rendering video 8 (frame image 19).

The rendering section 25 performs rendering processing such that the rendering video 8 (the frame image 19) obtained by the decoding can be displayed by the HMD 2.

The rendered frame image 19 is transmitted to the HMD 2 to be displayed to the user 5. This makes it possible to display the frame image 19 in real time in response to a change in the field of view 7 of the user 5.

### Processing of Cooperation Between Renderer and Encoder

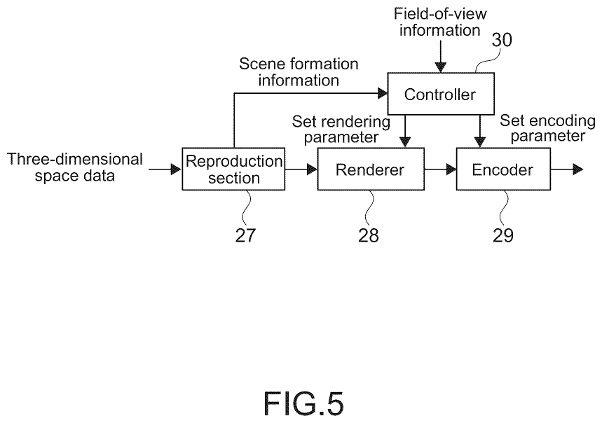

FIG. 5 schematically illustrates a specific example of respective configurations of the rendering section 14 and the encoding section 15 that are illustrated in FIG. 4.

In the present embodiment, a reproduction section 27, a renderer 28, an encoder 29, and a controller 30 are implemented in the server apparatus 4 as functional blocks.

These functional blocks are implemented by, for example, a CPU executing the program according to the present technology, and the information processing method according to the present embodiment is performed. Note that, in order to implement each functional block, dedicated hardware such as an integrated circuit (IC) may be used as appropriate.

On the basis of scene description information, the reproduction section 27 arranges a three-dimensional object to reproduce a three-dimensional space.

On the basis of the scene description information and field-of-view information, the controller 30 generates a rendering parameter used to give the renderer 28 instructions about how to perform rendering.

For example, the controller 30 specifies a rendering resolution, and specifies a region by foveated rendering as described later.

The rendering resolution is described.

The resolution (the number of pixels of V×H) of a frame image to be generated by rendering processing remains unchanged.

When rendering is performed such that different pixel values (gradation values) are set for respective pixels of the frame image 19, an image will be rendered at a resolution of the frame image 19. In other words, the resolution of an image to be rendered is identical to the resolution of the frame image 19.

On the other hand, when rendering is performed such that the same pixel value is set for pixels of a plurality of (for example, four) pixels put into a group, an image will be rendered at a lower resolution than the frame image 19.

In the present disclosure, the resolution of an image to be rendered is referred to as a rendering resolution.

Further, in the present disclosure, the expression of “being rendered at a high resolution” is used when an image to be rendered has a relatively higher resolution than a certain region (a pixel region). Further, the expression of “being rendered at a low resolution” is used when an image to be rendered has a relatively lower resolution than a certain region (a pixel region).

A distribution of a rendering resolution (a map of a resolution) of the generated frame image 19 can be used as a rendering parameter. For example, the controller 30 can set the rendering resolution for each region or each object on the basis of, for example, scene description information or current field-of-view information, and can inform the renderer 28 of the set rendering resolution.

Further, on the basis of the rendering parameter used to give the renderer 28 instructions, the controller 30 generates an encoding parameter used to give the encoder 29 instructions about how to perform encoding.

In the present embodiment, the controller 30 generates a QP map. The QP map corresponds to a quantization parameter set for two-dimensional video data.

For example, the quantization accuracy (a quantization parameter, QP) is changed for each region in the rendered frame image 19. This makes it possible to suppress a degradation in image quality that is caused due to a point of interest or an important region in the frame image 19 being compressed.

This makes it possible to suppress an increase in distribution data and processing burdens while maintaining a sufficient level of video quality with respect to a region important to the user 5.

Note that, here, a QP value is a value that represents a quantization step size upon lossy compression. When the QP value is large, an encoding amount is decreased and the compression efficiency is increased. This results in further degrading in image quality due to compression. On the other hand, when the QP value is small, the encoding amount is increased and the compression efficiency is reduced. This makes it possible to suppress a degradation in image quality that is caused due to compression.

The renderer 28 performs rendering on the basis of a rendering parameter output by the controller 30. The encoder 29 performs encoding processing (compression coding) on two-dimensional video data on the basis of a QP map output by the controller 30.

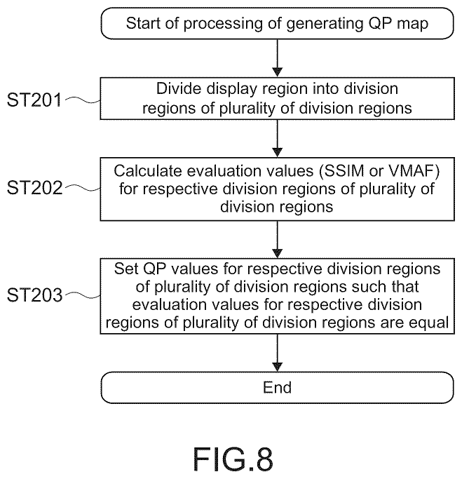

In the example illustrated in FIG. 8, the rendering section 14 illustrated in FIG. 4 is implemented by the reproduction section 27, the controller 30, and the renderer 28. Further, the encoding section 15 illustrated in FIG. 4 is implemented by the controller 30 and the encoder 29.

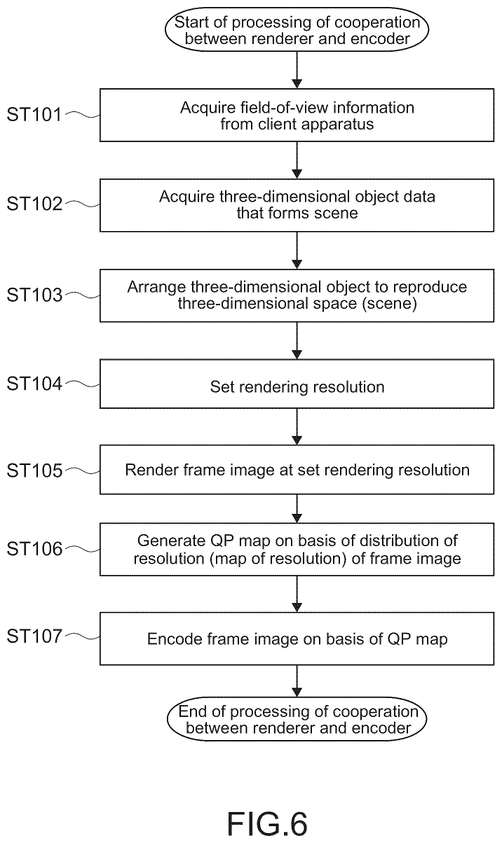

FIG. 6 is a flowchart illustrating an example of processing of cooperation between a renderer and an encoder. The processing of cooperation between a renderer and an encoder corresponds to processing of generating the rendering video 8 (the frame image 19) that is performed by the server apparatus 4.

The communication section 16 acquires field-of-view information regarding the field of view of the user 5 from the client apparatus 3 (Step 101).

The data input section 11 acquires three-dimensional object data that forms a scene (Step 102).

The reproduction section 27 arranges a three-dimensional object to reproduce a three-dimensional space (the scene) (Step 103).

The controller 30 sets a rendering resolution (Step 104).

The renderer 28 renders the frame image 19 at the set rendering resolution (Step 105). The rendered frame image 19 is output to the encoder 29.

The controller 30 generates a QP map on the basis of an in-plane distribution of the rendering resolution (a map of the resolution) of the frame image 19 (Step 106).

The encoder 29 performs encoding processing (compression coding) on the frame image 19 on the basis of the QP map (Step 107).

### Discussion Held by Inventors

The inventors have held numerous discussions in order to distribute a high-quality virtual image using processing of cooperation between a renderer and an encoder that is performed by the server-side rendering system 1. In particular, numerous discussions have been held on two points that are “rendering processing burdens” and a “degradation in image quality due to real-time encoding”.

Consequently, the inventors have devised a new technology related to a combination of rendering performed using a nonuniform resolution map and encoding performed using a nonuniform QP map based on the resolution map.

Note that the nonuniform resolution map is a resolution map that is set such that an in-plane distribution of a rendering resolution is nonuniform.

The nonuniform QP map is a QP map that is set such that an in-plane distribution of a QP value is nonuniform.

Rendering performed using a nonuniform resolution map can also be referred to as rendering performed at a nonuniform resolution. Further, encoding performed using a nonuniform QP map can also be referred to as encoding performed using a nonuniform QP.

First, the controller 30 sets a nonuniform resolution map in Step 104 of FIG. 6 in order to perform rendering using a nonuniform resolution map.

In the present embodiment, a region of interest and a region of non-interest are set in a display region in which two-dimensional video data (the frame image 19) is displayed.

The display region in which the frame image 19 is displayed is a viewport depending on the field of view 7 of the user 5, and corresponds to an image region for the frame image 19 to be rendered. The display region in which the frame image 19 is displayed is also a region of a rendering target, and can also be a rendering-target region or a rendering region.

The region of interest is a region to be rendered at a high resolution. The region of non-interest is a region of non-interest to be rendered at a low resolution.

For example, a region of interest to be rendered at a high resolution can be set to be a region to be rendered at the resolution of the frame image 19. Further, a region of non-interest to be rendered at a low resolution can be set to be a region to be rendered at a resolution lower than the resolution of the frame image 19. Of course, the settings are not limited to such settings.

In the present embodiment, foveated rendering is performed in order to set a region of interest and a region of non-interest. The foveated rendering is also referred to as fovea rendering.

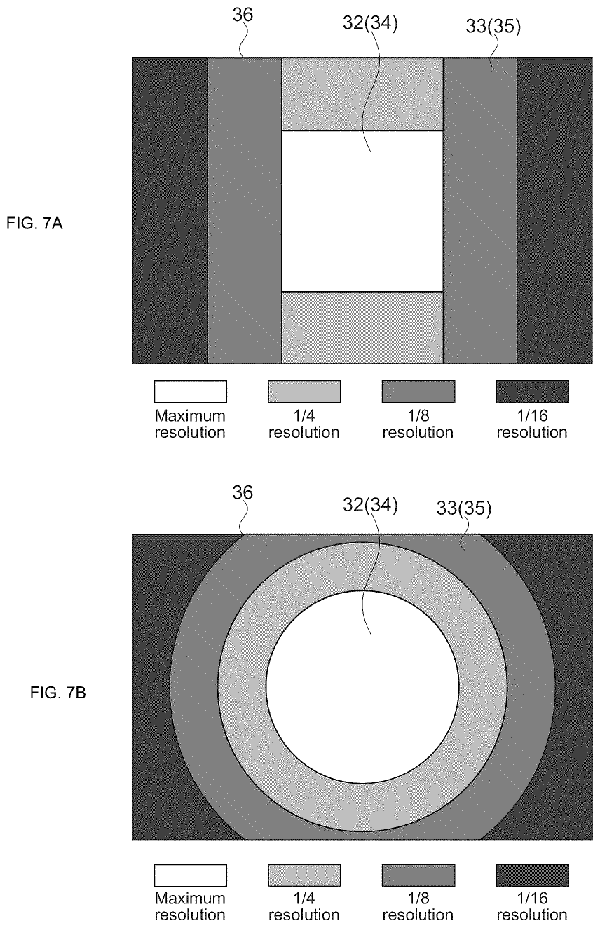

FIG. 7 is a schematic diagram used to describe an example of foveated rendering.

Foveated rendering is rendering performed according to human visual characteristics, where the resolution is high in a center portion of the field of view and is lower in a portion situated closer to an edge of the field of view.

For example, a field-of-view center region 32 that is obtained by partitioning the field of view to be rectangular or circular is rendered at a high resolution, as illustrated in A and B of FIG. 7. Further, a surrounding region 33 that surrounds the field-of-view center region 32 is partitioned into rectangular or circular regions, and the obtained regions are rendered at a low resolution.

In the examples illustrated in A and B of FIG. 7, the field-of-view center region 32 is rendered at a maximum resolution. For example, rendering is performed at the resolution of the frame image 19.

The surrounding region 33 is divided into three regions, and a region situated closer to an edge of the field of view is rendered at a lower resolution, that is, the three regions are respectively rendered at a resolution that is one quarter of the maximum resolution, a resolution that is one eighth of the maximum resolution, and a resolution that is one sixteenth of the maximum resolution.

In the examples illustrated in A and B of FIG. 7, the field-of-view center region 32 is set to be a region 34 of interest. Further, the surrounding region 33 is set to be a region 35 of non-interest. The region 35 of non-interest may be divided into a plurality of regions, and a rendering resolution may be gradually reduced, as illustrated in A and B of FIG. 7.

As described above, when foveated rendering is applied, a rendering resolution is set according to a two-dimensional location in a viewport (a display region) 36.

Note that positions of the field-of-view center region 32 (the region 34 of interest) and the surrounding region 33 (the region 35 of non-interest) are fixed in the examples illustrated in A and B of FIG. 7. Such foveated rendering is also referred to as fixed foveated rendering.

Without being limited thereto, the region 34 of interest being rendered at a high resolution may be dynamically set on the basis of a gaze point at which the user 5 is gazing. For example, a region that is centered at the gaze point and has a specified size is set to be the region 34 of interest. A region that surrounds the set region 34 of interest is the region 35 of non-interest being rendered at a low resolution.

Note that the gaze point of the user 5 can be calculated on the basis of field-of-view information regarding the field of view of the user 5. For example, the gaze point can be calculated on the basis of, for example, a direction of a line of sight or head-motion information. Of course, the gaze point itself is included in the field-of-view information. In other words, the gaze point may be used as the field-of-view information.

As described above, the region 34 of interest and the region 35 of non-interest may be dynamically set on the basis of field-of-view information regarding the field of view of the user 5.

Foveated rendering results in generating a resolution map having a nonuniform in-plane distribution of a rendering resolution.

Note that foveated rendering makes it possible to reduce rendering processing burdens and to reduce the processing time. This is advantageous in performing operation in real time.

### Generation of QP Map

FIG. 8 is a flowchart illustrating an example of generating a nonuniform QP map. Processing illustrated in FIG. 8 is performed by the controller 30 in Step 106 illustrated in FIG. 5 on the basis of the resolution map generated in Step 104.

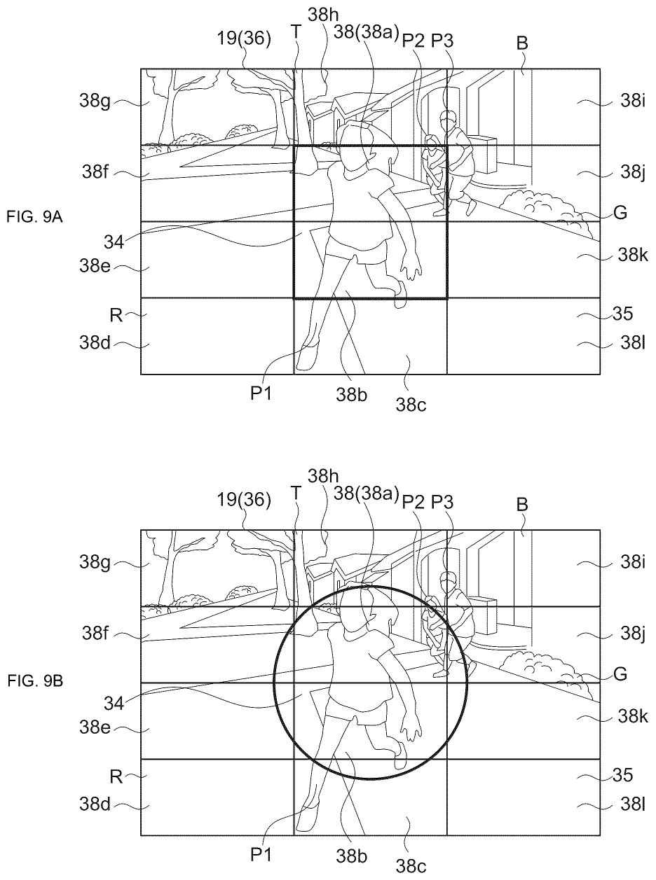

FIG. 9 is a schematic diagram used to describe processing of the generation illustrated in FIG. 8.

Here, an example of rendering the frame image 19 of a scene illustrated in FIG. 9 is described. In other words, it is assumed that the frame image 19 in which objects that are three persons P1 to P3, a tree T, a plant G, a road R, and a building B appear, is rendered.

Note that, actually, the trees of a plurality of the trees T in the frame image 19 are processed as objects different from each other and the plants of a plurality of the plants G in the frame image 19 are processed as objects different from each other, but the plurality of the trees T and the plurality of the plants G are respectively collectively referred to as the tree T and the plant G.

A of FIG. 9 illustrates the region 34 of interest and region 35 of non-interest being obtained when the foveated rendering illustrated in A of FIG. 7 is performed.

B of FIG. 9 illustrates the region 34 of interest and region 35 of non-interest being obtained when the foveated rendering illustrated in B of FIG. 7 is performed.

In A and B of FIG. 9, the field-of-view center region 32 is set to be the region 34 of interest, and the surrounding region 33 is set to be the region 35 of non-interest.

Note that, in A and B of FIG. 9, an illustration of partition performed to obtain regions of a plurality of regions in which the rendering resolution is gradually reduced in the region 35 of non-interest is omitted.

In Step 104 of FIG. 6, a high rendering resolution is set for the region 34 of interest, and a low rendering resolution is set for the region 35 of non-interest.

Specifically, the high rendering resolution is set for a region that corresponds to a portion of each object and is included in the region 34 of interest. The low rendering resolution is set for a region that corresponds to a portion of each object and is included in the region 35 of non-interest.

This results in generating a resolution map having a nonuniform in-plane distribution of a rendering resolution.

Note that, in the present embodiment, the controller 30 can acquire a depth map (a depth-map image) as a parameter related to rendering processing (hereinafter referred to as rendering information).

The depth map is data that includes distance information regarding a distance to a rendering-target object (depth information). The depth map can also be referred to as a depth-information map or a distance-information map.

For example, image data obtained by transforming a distance into brightness can be used as the depth map. Of course, the present technology is not limited to such a manner.

The depth-map image acquired as rendering information does not exhibit a depth value estimated by performing, for example, image analysis on the frame image 19, but an accurate value obtained in a process of rendering.

In other words, in the server-side rendering system 1, the user 5 renders a 2D video viewed by the user 5. Thus, an accurate depth map can be acquired without processing burdens imposed upon image analysis that corresponds to analyzing the 2D video after rendering.

The use of the depth map makes it possible to detect whether one of objects arranged in a three-dimensional space (the virtual space) S is ahead of or behind another of the objects, and thus to accurately detect a shape and a contour of each of the objects.

Thus, the present embodiment makes it possible to set the rendering resolution with a high degree of accuracy for each object. Of course, the region corresponding to a portion of each object and being included in the region 34 of interest and the region corresponding to a portion of the object and being included in the region 35 of non-interest can also be detected with a high degree of accuracy, and the high or low rendering resolution can be set accurately.

In other words, the present embodiment makes it possible to generate an accurate resolution map.

As illustrated in FIG. 8, the display region 36 in which two-dimensional video data (the frame image 19) is displayed is divided into division regions 38 of a plurality of division regions 38 (38a to 38l) (Step 201).

In the example illustrated in A and B of FIG. 9, rectangular division regions 38 having the same size are placed side by side in a grid in vertical (V) and horizontal (H) directions of the frame image 19. Specifically, twelve division regions 38 in total are set to be the plurality of division regions 38 being obtained by dividing the display region 36 in which two-dimensional video data (the frame image 19) is displayed, where four division regions 38 are placed in the vertical (V) direction and three division regions 38 are placed in the horizontal (H) direction.

In the example illustrated in A of FIG. 9, a plurality of division regions 38 is set such that a boundary of the region 34 of interest and the region 35 of non-interest coincides with boundaries of division regions 38 of the plurality of division regions 38. Further, two division regions 38a and 38b in a center portion are the same as the region 34 of interest. Ten division regions 38c to 38l that surround the division regions 38a and 38b are the same as the region 35 of non-interest.

In the example illustrated in B of FIG. 9, the plurality of division regions 38 is set without the boundary of the region 34 of interest and the region 35 of non-interest coinciding with the boundaries of the division regions 38 of the plurality of division regions 38.

As described above, a plurality of division regions 38 may be set such that the boundary of the region 34 of interest and the region 35 of non-interest coincides with the boundaries of the division regions 38 of the plurality of division regions 38, or the plurality of division regions 38 may be set such that the boundary of the region 34 of interest and the region 35 of non-interest does not coincide with the boundaries of the division regions 38 of the plurality of division regions 38.

Moreover, the number of the plurality of division regions 38 obtained by dividing the display region 36, a shape of the division region 38, a size of the division region 38, and the like are not limited, and may be set discretionarily. The division regions 38 of the plurality of division regions 38 are not limited to having the same shape or to having the same size, and the respective division regions 38 may have different shapes or different sizes.

Evaluation values obtained by numerically expressing a degradation in image quality that is caused due to encoding are calculated for the respective division regions 38 of the plurality of division regions 38 (Step 202).

An image-quality evaluation indicator in which human perceptual characteristics are reflected is used as the evaluation value. In the present embodiment, a value of structural similarity (SSIM) or Video Multimethod Assessment Fusion (VMAF) is calculated as the evaluation value.

In other words, in Step 202, the controller 30 calculates the values of structural similarity (SSIM) as the evaluation values for the respective division regions 38 of the plurality of division regions 38. Alternatively, the controller 30 calculates the values of Video Multimethod Assessment Fusion (VMAF) as the evaluation values for the respective division regions 38 of the plurality of division regions 38.

In the example illustrated in A and B of FIG. 9, the values of SSIM are respectively calculated for the twelve division regions 38a to 38l. Alternatively, the values of VMAF are respectively calculated for the twelve division regions 38a to 38l.

Thus, in the present embodiment, a parameter set that includes twelve evaluation values (SSIM or VMAF) is calculated.

Note that, in Step 202, it is sufficient if at least one of a value of SSIM or a value of VMAF can be calculated for each of the plurality of division regions 38.

For example, whether values of SSIM or values of VMAF are to be calculated for the respective division regions 38 of the plurality of division regions 38 by the controller 30, which can calculate both the value of SSIM and the value of VMAF, may be selectable.

On the other hand, without being limited thereto, the present technology also includes calculating the values of SSIM for the respective division regions 38 of the plurality of division regions 38, the calculation being performed by the controller 30, which can only calculate the value of SSIM. Further, the present technology also includes calculating the values of VMAF for the respective division regions 38 of the plurality of division regions 38, the calculation being performed by the controller 30, which can only calculate the value of VMAF.

The values of SSIM or the values of VMAF can be calculated for the respective division regions of the plurality of division regions using a well-known technology.

QP values (quantization parameters) are set for the respective division regions 38 of the plurality of division regions 38 such that the evaluation values for the respective division regions of the plurality of division regions are equal (Step 203).

In the example illustrated in A and B of FIG. 9, QP values are set for the twelve division regions 38a to 38l such that twelve values of SSIM or twelve values of VMAF that correspond to the twelve division regions 38a to 38l are equal.

Note that, in the present disclosure, an expression of “uniform/equal” includes, in concept, an expression of “substantially uniform/substantially equal”. This will also be described later. For example, the expression of “uniform/equal” also includes a state within a specified range (such as a range of +/−10%), with, for example, an expression of “exactly uniform/exactly equal” being used as a reference.

Thus, setting QP values for the respective division regions 38 such that evaluation values for the respective division regions 38 are “equal” includes determining the QP values such that the evaluation values are identical to or similar to each other.

Further, the setting the QP values for the respective division regions such that the evaluation values are “equal” includes adjusting the QP values for the respective division regions 38 such that the evaluation values approximate to being “equal”. For example, it is assumed that the QP values for the respective division regions 38 are adjusted such that greatly varying evaluation values of a plurality of greatly varying evaluation values (SSIM or VMAF) approximate to being closer to being “equal” than in the greatly varying state. Such a case is also included in the setting the QP values for the respective division regions 38 of the plurality of division regions 38 such that the evaluation values for the respective division regions 38 are equal.

Note that an evaluation value for each division region 38 is increased if a QP value for the division region 38 is decreased. The evaluation value is decreased if the QP value is increased. Thus, the QP value is decreased for the division region 38 that is included in a plurality of division regions 38 and for which the evaluation value is to be increased. Further, the QP value is increased for the division region 38 that is included in the plurality of division regions 38 and for which the evaluation value is to be decreased. Such processing may be performed as adjustment of a QP value.

For example, first, QP values are set for the respective division regions 38, and then evaluation values are calculated. The QP values are adjusted according to a result of the calculation. Such feedback processing may be performed.

The process of Step 203 can also be a process of causing evaluation values for respective division regions of a plurality of division regions to vary in a specified range.

A difference between a maximum value and a minimum value of evaluation values, a variance value of the evaluation values, or the like can be used as a parameter that indicates a variation in evaluation value. For example, a QP value may be adjusted by performing, for example, threshold processing using the parameter indicating the variation such that evaluation values vary in a specified range.

When the QP values for the respective division regions 38 of the plurality of division regions 38 are determined, generation of a QP map is completed. The QP map corresponds to a collection of the QP values for the respective division regions 38 of the plurality of division regions 38.

### Example of Processing of Determining QP Value

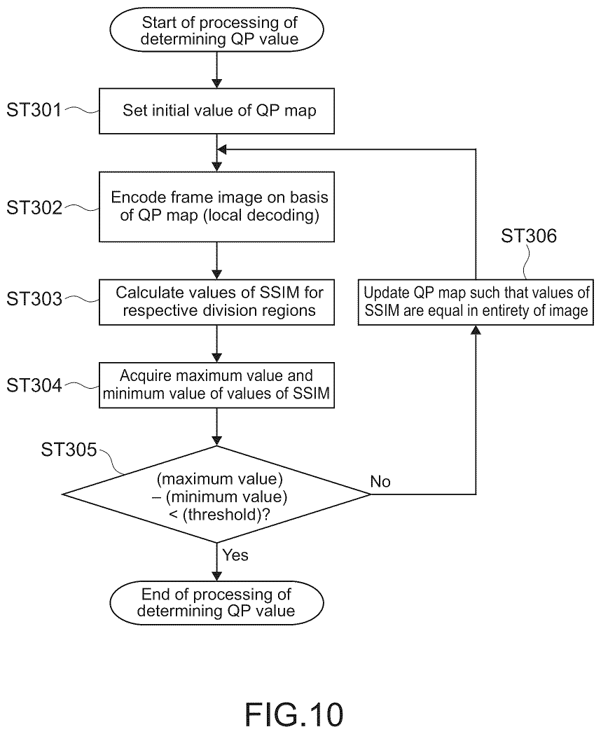

FIG. 10 is a flowchart illustrating an example of determining QP values for respective division regions 38 of a plurality of division regions 38.

Processing illustrated in FIG. 10 corresponds to an embodiment of the processes of Steps 202 and 203 illustrated in FIG. 9. Further, the processing illustrated in FIG. 10 is performed for each frame image 19.

Here, an example of calculating a value of SSIM as an evaluation value is described.

First, an initial value of a QP map is set (Step 301). In other words, initial values of QP values are set for the respective division regions 38 of the plurality of division regions 38.

For example, a QP map set for a most recent previous frame image 19 is set to be an initial value of a QP map for a current frame image 19.

Alternatively, when an encoding approach using a frame-correlation compression such as Moving Picture Experts Group (MPEG) is applied, for example, a QP map obtained by performing averaging for each group of pictures (GOP) or a QP map obtained by performing averaging at intervals of a key frame may be set to be an initial value.

For example, an average of QP maps each of which is set for, for example, an I-frame (an intra picture), a P-frame (a predictive picture), or a B-frame (a bidirectionally predictive picture) may be set to be an initial value of a QP map for a current frame image 19, the I-frame, the P-frame, and the B-frame being included in a GOP.

Alternatively, an average of QP maps set for a most recent previous key frame to a most recent previous frame image 19 may be set to be an initial value of a QP map for a current frame image 19.

Moreover, any method may be adopted as the method for setting an initial value of a QP map.

The frame image 19 is encoded on the basis of an initial value of a QP map. Further, local decoding is performed by the encoder 29, and the encoded frame image 19 is decoded (Step 302).

Values of SSIM for the respective division regions 38 of the plurality of division regions 38 are calculated on the basis of the frame image 19 (an original image) before encoding and on the basis of the frame image 19 obtained by the frame image 19 (an image after encoding) being decoded by local decoding (Step 303).

A maximum value and a minimum value of the calculated values of SSIM are acquired (Step 304).

It is determined whether a difference between the maximum value and the minimum value of the values of SSIM is less than a specified threshold (Step 305). Note that a specific value of the threshold is not limited, and may be set discretionarily.

When the difference between the maximum value and the minimum value of the values of SSIM is not less than the threshold (No in Step 305), the QP map is updated such that the values of SSIM are equal in the entirety of an image (Step 306). In other words, the QP values for the respective division regions 38 of the plurality of division regions 38 are updated such that the values of SSIM are equal in the entirety of the image.

For example, with respect to the division region 38 having a relatively small value of SSIM, setting is performed such that the QP value is reduced and the degree of compression is made lower. With respect to the division region 38 having a relatively large value of SSIM, setting is performed such that the QP value is increased and the degree of compression is made higher. Of course, these two processes may be performed together.

The processes of Steps 302 to 305 are performed on the basis of the updated QP map, and it is determined again whether the difference between the maximum value and the minimum value of the values of SSIM is less than the specified threshold (Step 305).

The loop of the processes of Steps 302 to 306 is repeated to cause the QP value to converge. When the difference between the maximum value and the minimum value is less than the specified threshold in Step 305, it is determined that an optimal QP map has been obtained, and the processing of determining a QP value is terminated.

In the present embodiment, a difference between a maximum value and a minimum value of evaluation values (SSIM) for respective division regions 38 of a plurality of division regions 38 is calculated, and QP values are set for the respective division regions of the plurality of division regions such that the difference is less than a specified threshold, as described above.

Of course, the processing of determining a QP value can also be performed when a value of VMAF is calculated as an evaluation value.

### Setting of High-Resolution Region and Low-Resolution Region (Another Method for Setting Division Region)

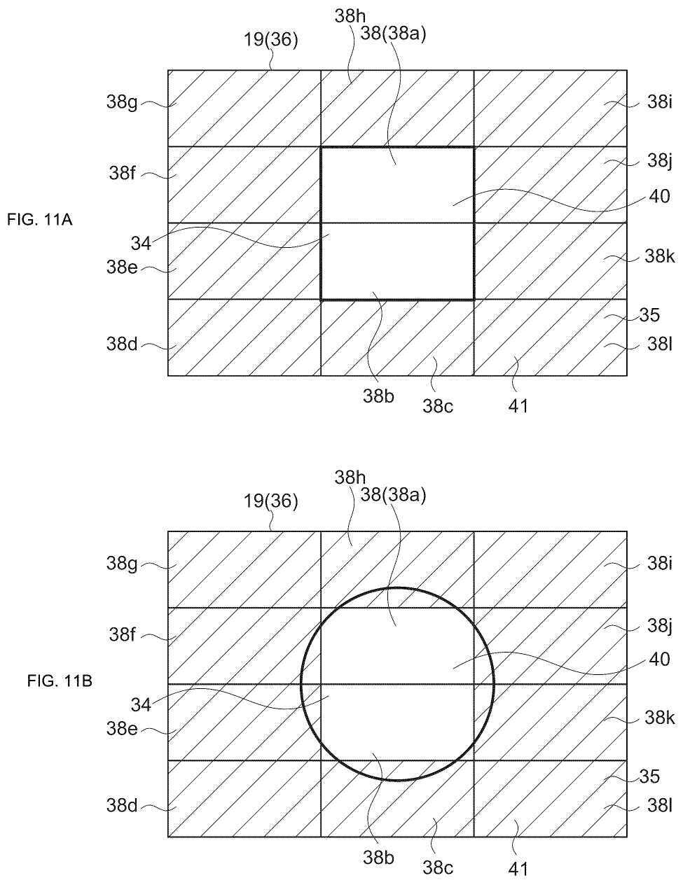

FIG. 11 is a schematic diagram used to describe another method for setting a plurality of division regions.

In A of FIG. 11, illustrations of the respective objects appearing in the frame image 19 illustrated in A of FIG. 9 are omitted.

In B of FIG. 11, illustrations of the respective objects appearing in the frame image 19 illustrated in B of FIG. 9 are omitted.

The example in which twelve division regions 38 obtained by dividing the display region 36 are used as an embodiment of division regions according to the present technology has been described in A and B of FIG. 9.

Here, another embodiment of the division regions according to the present technology is described using the twelve division regions 38. Thus, the twelve division regions 38 do not correspond to an embodiment of the division regions according to the present technology. The twelve division regions 38 are hereinafter simply referred to as twelve regions 38 using the same reference numeral, in order to facilitate understanding of the description.

In the present embodiment, a high-resolution region 40 and a low-resolution region 41 are set to be a plurality of division regions. In other words, two division regions (the high-resolution region 40 and the low-resolution region 41) are set in the present embodiment.

The high-resolution region 40 is set to be a region primarily rendered at a high resolution by the renderer 28.

The low-resolution region 41 is set to be a region primarily rendered at a low resolution by the renderer 28.

In the present embodiment, the high-resolution region 40 and the low-resolution region 41 are set on the basis of the region 34 of interest and region 35 of non-interest being set by foveated rendering.

In other words, on the basis of respective positions of the region 34 of interest and the region 35 of non-interest in the display region 36 in which the frame image 19 is displayed, the high-resolution region 40 and the low-resolution region 41 are set to be a plurality of division regions in the display region 36.

In other words, in the present embodiment, the rendering section 14 generates two-dimensional video data (the frame image 19) such that the resolution of the two-dimensional video data is nonuniform in the display region 36 in which the two-dimensional video data is displayed.

Further, the encoding section 15 divides the two-dimensional video data (the frame image 19) into a plurality of division regions on the basis of the distribution of a resolution of the generated two-dimensional video data (the frame image 19).

In the example illustrated in A of FIG. 11, the two regions 38a and 38b in a center portion are set to be the high-resolution region 40. Thus, the high-resolution region 40 is the same as the region 34 of interest set by foveated rendering.

Further, the ten regions 38c to 38l surrounding the regions 38a and 38b are set to be the low-resolution region 41. Thus, the low-resolution region 41 is the same as the region 35 of non-interest set by the foveated rendering.

In the example illustrated in B of FIG. 11, the two regions 38a and 38b in a center portion are also set to be the high-resolution region 40. The ten surrounding regions 38a to 38l are set to be the low-resolution region 41.

In the example illustrated in B of FIG. 11, the high-resolution region 40 and the region 34 of interest are not the same as each other. Further, the low-resolution region 41 and the region 35 of non-interest are not the same as each other.

On the other hand, the high-resolution region 40 and the low-resolution region 41 can be set in each region 38 on the basis of, for example, a size of a region included in the region 34 of interest and a size of a region included in the region 35 of non-interest.

In other words, the high-resolution region 40 and the low-resolution region 41 can be easily accurately set on the basis of the region 34 of interest and region 35 of non-interest being set by foveated rendering.

Evaluation values are calculated for the high-resolution region 40 and low-resolution region 41 being set as described above, that is, two evaluation values are calculated.

Then, QP values are respectively set for the high-resolution region 40 and the low-resolution region 41 such that respective evaluation values for the high-resolution region 40 and the low-resolution region 41 are equal.

For example, the same OP value, which is a QP value for the high-resolution region 40, is set for the two regions 38a and 38b in the center portion. The same QP value, which is a QP value for the low-resolution region 41, is set for the ten surrounding regions 38a to 38l.

In other words, a parameter set that includes twelve QP values may be generated as a QP map. Of course, without being limited thereto, a QP map that includes two QP values that are a QP value for the entirety of the high-resolution region 40 and a QP value for the entirety of the low-resolution region 41 may be generated.

In Step 301 of FIG. 10, an initial value of a QP map is set. In other words, initial values of QP values are respectively set for the high-resolution region 40 and the low-resolution region 41.

Here, for the high-resolution region 40, a first QP value (a first quantization parameter) may be set to a fixed value. In other words, a QP value set for the high-resolution region 40 may be set to not be updated.

The method for determining an initial value (a fixed value) is not limited, and may be set discretionarily. For example, the first QP value may be set on the basis of, for example, the image quality in the high-resolution region 40 and a bit rate in the entirety of an image.

For example, a degradation in image quality that is caused due to encoding is to be suppressed in the high-resolution region 40. Thus, for the high-resolution region 40, the first QP value, which is a relatively small value, is set to a fixed value.

Further, an amount of bits occurring in the high-resolution region 40 often accounts for a dominant proportion of an amount of bits occurring in the entirety of an image. Thus, the bit rate in the entirety of an image is often greatly affected by the degree of compression rate set for the high-resolution region 40. Thus, the first QP value, which is a specified value, is set to a fixed value such that the bit rate in the entirety of an image exhibits a desired value.

Such a setting method is an example. Of course, the present technology is not limited thereto.

A second QP value (a second quantization parameter) that is larger than the first QP value is set for the low-resolution region 41 as an initial value.

Then, the second QP value is adjusted such that the evaluation value for the low-resolution region 41 is equal to the evaluation value for the high-resolution region 40. In other words, in the present embodiment, the second QP value is set by loop processing being performed, such that the evaluation value for the low-resolution region 41 is equal to the evaluation value for the high-resolution region 40.

For example, in Step 302, the frame image 19 is encoded using the first QP value (a fixed value) set for the high-resolution region 40 and the second QP value (an adjustment-target value) set for the low-resolution region 41. Further, the encoded frame image 19 is decoded by local decoding.

In Step 303, respective evaluation values for the high-resolution region 40 and the low-resolution region 41 are calculated.

For example, respective values of SSIM for the high-resolution region 40 and the low-resolution region 41 may be calculated at a time in response to information regarding the entirety of the region being input. Alternatively, a value of SSIM for the high-resolution region 40 and a value of SSIM for the low-resolution region 41 may be calculated by calculating values of SSIM for the regions 38 included in each of the high-resolution region 40 and the low-resolution region 41 and by performing statistical processing such as averaging.

The two calculated evaluation values respectively correspond to a maximum value and a minimum value (Step 304).

It is determined, in Step 304, whether a difference between the evaluation value for the high-resolution region 40 and the evaluation value for the low-resolution region 41 is less than a specified threshold.

When the difference between the evaluation value for the high-resolution region 40 and the evaluation value for the low-resolution region 41 is not less than the specified threshold, the second QP value set for the low-resolution region 41 is updated in Step 306.

As described above, the second QP value is set for the low-resolution region 41 such that a difference between an evaluation value for the low-resolution region 41 and an evaluation value for the high-resolution region 40 is less than a specified threshold.

Here, when the high-resolution region 40 was encoded with the QP value for the high-resolution region 40 being fixed to 25, the value of SSIM for the high-resolution region 40 was about 0.978.

Next, the QP value was obtained such that the value of SSIM for the low-resolution region 41 is 0.978 when the low-resolution region 41 is encoded.

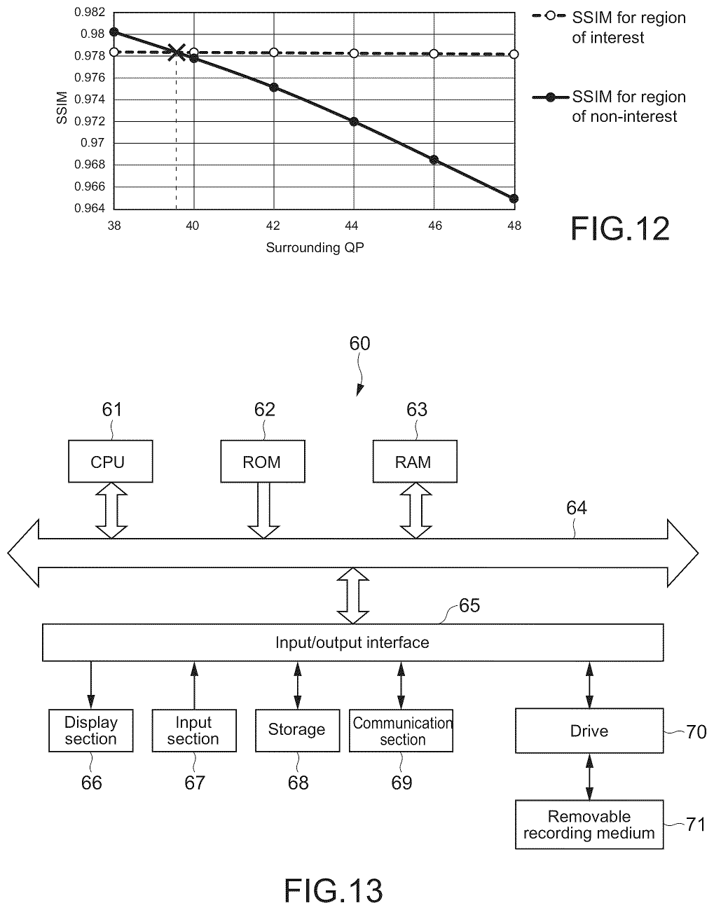

FIG. 12 is a graph in which the value of SSIM for the low-resolution region 41 when the second QP value for the low-resolution region 41 is changed from 38 to 48, is given. Further, FIG. 12 also illustrates the value of SSIM for the high-resolution region 40. Furthermore, FIG. 12 illustrates a surrounding QP as the second QP value.

The first QP value for the high-resolution region 40 is a fixed value. Thus, the value of SSIM for the high-resolution region 40 is constant. Here, the second QP value for the low-resolution region 41, which corresponds to a point of intersection of a line representing the value of SSIM for the low-resolution region 41 and a line representing the value of SSIM for the high-resolution region 40 is about 39.6. When the second QP value is set to this value, the value of SSIM for the high-resolution region 40 and the value of SSIM for the low-resolution region are identical to each other.

The repetition of the loop of Steps 302 to 306 results in adjusting the second QP value such that the second QP value is close to the value of about 39.6.

The controller 30 may generate a function in which the second QP value is set to be input and the value of SSIM is set to be output. In other words, a function that is represented by the graph related to the second QP value and illustrated in FIG. 12 may be calculated.

Then, on the basis of the generated function, the second QP value may be calculated such that the respective evaluation values for the high-resolution region 40 and the low-resolution region 41 are equal.

The region 34 of interest and region 35 of non-interest being set by foveated rendering may be respectively used as the high-resolution region 40 and the low-resolution region 41 with no change.

In other words, regions set in a process of rendering may be used as an embodiment of a plurality of division regions according to the present technology with no change. In this case, it can also be said that the rendering section 14 sets the plurality of division regions.

Further, object regions may be used as an embodiment of the plurality of division regions according to the present technology. For example, the regions of the respective objects illustrated in FIG. 9 and corresponding to the three persons P1 to P3, the tree T, the plant G, the road R, and the building B may be used as the plurality of division regions.

Further, a QP value for each region determined using a QP map or a QP value for each object may be arranged by the encoder 29 to be a QP value for each block having a size of, for example, 16 (pixels)×16 (pixels), and the QP value for each block may be used. In this case, encoding processing is performed for each block.

The blocks set to perform such encoding processing can also be used as an embodiment of the plurality of division regions according to the present technology.

In the server-side rendering system 1 according to the present embodiment, the server apparatus 4 calculates values of SSIM or VMAF as evaluation values for respective division regions of a plurality of division regions obtained by dividing the display region 36 in which the frame image 19 is displayed, as described above. Further, QP values are set for the respective division regions of the plurality of division regions such that the evaluation values for the respective division regions of the plurality of division regions are equal. This makes it possible to distribute high-quality virtual videos.

For example, a method including setting a fixed offset value to be a QP value according to a rendering resolution of each region of the rendered frame image 19, is conceivable.

In this method, a QP value is set regardless of the complexity of an image (a level of difficulty in encoding) and the noticeability of a degradation in subjective image quality. Thus, the subjective image qualities in respective regions vary in an image after encoding and decoding.

For example, it is assumed that the entirety of an image has a resolution of 4K (3840×2160) and a rendering resolution of the region 34 of interest being set in a center portion of the image is set to be equivalent to the 4K resolution. It is assumed that blurring processing or the like is performed on a region situated outside of the region 34 of interest and a rendering resolution of the outside region is equivalent to the HD (1920×1080) resolution.

In this case, a QP value when the region of the HD resolution is encoded is set to a value obtained by a QP value when the region 34 of interest is encoded being offset by a fixed value, that is, for example, by an increment of four. The increase in QP value results in the outside region being encoded to be more highly compressed.

Further, when a region situated outside of the HD-resolution region has a rendering resolution equivalent to the SD (720×480) resolution, a value obtained by the QP value for the region 34 of interest being incremented by eight is used as a QP value.

As described above, the QP value is offset to perform encoding according to the rendering resolution of each region. This makes it possible to reduce the bit rate in total. Alternatively, a margin for bit rate that is obtained due to the outside region being highly compressed is applied to the region 34 of interest (the QP value for the region 34 of interest is made smaller). This may make it possible to further suppress a degradation in the image quality in the region 34 of interest that is caused due to encoding.

However, in this method, a fixed QP offset value is determined only using a value of a rendering resolution regardless of details of an image (a level of difficulty in encoding) and the noticeability of a degradation in subjective image quality. Thus, there is a good possibility that the subjective image qualities in respective regions will vary in an image after encoding and decoding.

A method including calculating an objective amount of noise produced when each of regions of different rendering resolutions in the rendered frame image 19 is encoded and determining a QP value on the basis of a value of the calculated objective amount of noise produced, is also conceivable.

An objective evaluation indicator such as mean squared error (MSE) or peak signal-to-noise ratio (PSNR) that indicates a degradation in image quality due to encoding can be used to calculate the noise amount. A method including calculating a value of MSE or PSNR for each of the regions of different rendering resolutions and determining a QP value for each of the regions of different rendering resolutions such that the regions of different rendering resolutions exhibit similar values of MSE or PSNR, is conceivable.

However, in this method, degrees of degradation in subjective image quality will not be necessarily similar to each other even if values of the objective evaluation indicator such as MSE or PSNR are identical. Thus, there is a good possibility that the image qualities (the degrees of degradation in subjective image quality) will vary.

MSE and PSNR each indicate a so-called sum total of differences between an image before encoding and an image after encoding and decoding. This exhibits an objective numerical value, but does not necessarily reflect a subjective image quality.

In the server-side rendering system 1 according to the present embodiment, SIMM or VMAF, which is an image-quality evaluation indicator in which human perceptual characteristics are reflected, is used. This makes it possible to equalize a variation in subjective image quality in any image.

This makes it possible to generate an image with a uniform degradation in image quality without a degradation in image quality in a specific portion being noticeable, and thus to provide, to the user 5, an image that is subjectively natural and does not bring an uncomfortable feeling.

In other words, this makes it possible to sufficiently prevent generation of an image that has a partial degradation in a certain region of the image, or an image that has an excessively precise region and makes the user 5 feel uncomfortable.

Further, the application of the present technology makes it possible to set a specific QP value for each division region in the frame image 19 having a nonuniform in-plane distribution of a rendering resolution. Bits are appropriately allocated to division regions obtained by dividing an image. Thus, encoding can be performed efficiently with respect to a bit rate.

The present embodiment makes it possible to reduce rendering processing burdens and to suppress a degradation in image quality that is caused due to encoding being performed in real time, as described above.

### Other Embodiments

The present technology is not limited to the embodiments described above, and can achieve various other embodiments.

The present technology can also be applied to the case in which the region 34 of interest set by foveated rendering is further divided into a plurality of regions.

A method including rendering a narrower range at a high resolution using line-of-sight information (field-of-view information) that indicates what portion of the region 34 of interest the user 5 is actually gazing at, instead of rendering, at a high resolution, the entirety of the region 34 of interest situated in a center portion of the field of view, is conceivable as a method for reducing a data amount of the region 34 of interest in an image on which foveated rendering has been performed.

For example, the person P1 is set to be a gaze object in the region 34 of interest illustrated in A and B of FIG. 9. Further, objects other than the person P1 are set to be non-gaze objects in the region 34 of interest.

The person P1 corresponding to a gaze object is rendered at a high-resolution, and a data amount is reduced for the non-gaze objects corresponding to objects other than the gaze object. Examples of the data amount reducing processing include any processing performed to reduce an amount of data of an image, such as blurring processing, a reduction in rendering resolution, grayscaling, a reduction in a gradation value of an image, and a transformation of a mode for displaying an image.

Consequently, a substantial data amount of the frame image 19 before being input to the encoder can be reduced to a necessary minimum without a loss in subjective image quality. This enables the encoding section 15 situated on the output side to decrease a substantial data compression rate without an increase in bit rate, and to suppress a degradation in image quality that is caused due to compression.

In such a case, for example, a region that corresponds to a gaze object in the region 34 of interest, and a region that corresponds to a non-gaze object that is an object other than the gaze object are set to be different division regions. Then, QP values are set for the respective division regions such that evaluation values (SSIM or VMAF) for the respective division regions are equal. This makes it possible to make a degradation in image quality in the region 34 of interest uniform, and to sufficiently prevent a local degradation in image quality from being noticeable.

When processing of repeatedly updating QP values for respective division regions of a plurality of division regions is performed by performing encoding in real time, this may result in heavy processing burdens. Thus, for example, setting to move on to encoding of a next frame at a timing at which the difference is within a certain range without evaluation values (SSIM or VMAF) for respective division regions being completely equal, may be adopted.

Further, an upper limit may be set for the number of repetition of an update of a QP value.

A plurality of division regions may be updated such that evaluation values (SSIM or VMAF) for respective division regions of the plurality of division regions are equal. In other words, the number of division regions, a shape of the division region, a size of the division region, and the like may be updated such that the evaluation values for the respective division regions are equal.

The example in which a full 360-degree spherical video 6 (a 6-DoF video) including, for example, 360-degree space video data is distributed as a virtual image, has been described above. Without being limited thereto, the present technology can also be applied when, for example, a 3DoF video or a 2D video is distributed. Further, not a VR video but, for example, an AR video may be distributed as a virtual image.

Furthermore, the present technology can also be applied to a stereo video (such as a right-eye image and a left-eye image) used to view a 3D image.

FIG. 13 is a block diagram illustrating an example of a hardware configuration of a computer 60 (an information processing apparatus) by which the server apparatus 4 and the client apparatus 3 can be implemented.

The computer 60 includes a CPU 61, a read only memory (ROM) 62, a RAM 63, an input/output interface 65, and a bus 64 through which these components are connected to each other. A display section 66, an input section 67, a storage 68, a communication section 69, a drive 70, and the like are connected to the input/output interface 65.

The display section 66 is a display device using, for example, liquid crystal or EL. Examples of the input section 67 include a keyboard, a pointing device, a touch panel, and other operation apparatuses. When the input section 67 includes a touch panel, the touch panel may be integrated with the display section 66.

The storage 68 is a nonvolatile storage device, and examples of the storage 68 include an HDD, a flash memory, and other solid-state memories. The drive 70 is a device that can drive a removable recording medium 71 such as an optical recording medium or a magnetic recording tape.

The communication section 69 is a modem, a router, or another communication apparatus that can be connected to, for example, a LAN or a WAN and is used to communicate with another device. The communication section 69 may perform communication wirelessly or by wire. The communication section 69 is often used in a state of being separate from the computer 60.

Information processing performed by the computer 60 having the hardware configuration described above is performed by software stored in, for example, the storage 68 or the ROM 62, and hardware resources of the computer 60 working cooperatively. Specifically, the information processing method according to the present technology is performed by loading, into the RAM 63, a program included in the software and stored in the ROM 62 or the like and executing the program.

For example, the program is installed on the computer 60 through the recording medium 61. Alternatively, the program may be installed on the computer 60 through, for example, a global network. Moreover, any non-transitory computer-readable storage medium may be used.

The information processing method and the program according to the present technology may be executed and the information processing apparatus according to the present technology may be implemented by a plurality of computers working cooperatively, the plurality of computers being a plurality of computers communicatively connected to each other through, for example, a network.

In other words, the information processing method and the program according to the present technology can be executed not only in a computer system that includes a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both the case in which the acquisition of field-of-view information, the execution of rendering processing, the setting of a rendering resolution (the generation of a resolution map), the setting of a plurality of division regions, the calculation of an evaluation value, the setting of a QP value (the generation of a QP map), and the like are executed by a single computer; and the case in which the respective processes are executed by different computers. Further, the execution of the respective processes by a specified computer includes causing another computer to execute a portion of or all of the processes and acquiring a result of it.

In other words, the information processing method and the program according to the present technology are also applicable to a configuration of cloud computing in which a single function is shared and cooperatively processed by a plurality of apparatuses through a network.

The respective configurations of the server-side rendering system, the HMD, the server apparatus, the client apparatus, and the like; the respective processing flows; and the like described with reference to the respective figures are merely embodiments, and any modifications may be made thereto without departing from the spirit of the present technology. In other words, for example, any other configurations or algorithms for purpose of practicing the present technology may be adopted.

In the present disclosure, wording such as “substantially”, “almost”, and “approximately” is used as appropriate in order to facilitate the understanding of the description. On the other hand, whether the wording such as “substantially”, “almost”, and “approximately” is used does not result in a clear difference.

In other words, in the present disclosure, expressions, such as “center”, “middle”, “uniform/equal”, “same”, “similar”, “orthogonal”, “parallel”, “symmetric”, “extend”, “axial direction”, “columnar”, “cylindrical”, “ring-shaped”, and “annular” that define, for example, a shape, a size, a positional relationship, and a state respectively include, in concept, expressions such as “substantially the center/substantial center”, “substantially the middle/substantially middle”, “substantially uniform/substantially equal”, “substantially the same”, “substantially similar”, “substantially orthogonal”, “substantially parallel”, “substantially symmetric”, “substantially extend”, “substantially axial direction”, “substantially columnar”, “substantially cylindrical”, “substantially ring-shaped”, and “substantially annular”.

For example, the expressions such as “center”, “middle”, “uniform/equal”, “same”, “similar”, “orthogonal”, “parallel”, “symmetric”, “extend”, “axial direction”, “columnar”, “cylindrical”, “ring-shaped”, and “annular” also respectively include states within specified ranges (such as a range of +/−10%), with expressions such as “exactly the center/exact center”, “exactly the middle/exactly middle”, “exactly uniform/exactly equal”, “exactly the same”, “exactly similar”, “completely orthogonal”, “completely parallel”, “completely symmetric”, “completely extend”, “fully axial direction”, “perfectly columnar”, “perfectly cylindrical”, “perfectly ring-shaped”, and “perfectly annular” being respectively used as references.

Thus, an expression that does not include the wording such as “substantially”, “almost”, and “approximately” can also include, in concept, a possible expression including the wording such as “substantially”, “almost”, and “approximately”. Conversely, a state expressed using the expression including the wording such as “substantially”, “almost”, and “approximately” may include a state of “exactly/exact”, “completely”, “fully”, or “perfectly”.

In the present disclosure, an expression using “-er than” such as “being larger than A” and “being smaller than A” comprehensively includes, in concept, an expression that includes “being equal to A” and an expression that does not include “being equal to A”. For example, “being larger than A” is not limited to the expression that does not include “being equal to A”, and also includes “being equal to or greater than A”. Further, “being smaller than A” is not limited to “being less than A”, and also includes “being equal to or less than A”.

When the present technology is carried out, it is sufficient if a specific setting or the like is adopted as appropriate from expressions included in “being larger than A” and expressions included in “being smaller than A”, in order to provide the effects described above.

At least two of the features of the present technology described above can also be combined. In other words, the various features described in the respective embodiments may be combined discretionarily regardless of the embodiments. Further, the various effects described above are not limitative but are merely illustrative, and other effects may be provided.

Note that the present technology may also take the following configurations.

(1) An information processing apparatus, including:
a rendering section that performs rendering processing on three-dimensional space data on the basis of field-of-view information regarding a field of view of a user to generate two-dimensional video data depending on the field of view of the user; and
an encoding section that
   calculates, as evaluation values, values of structural similarity (SSIM) or values of Video Multimethod Assessment Fusion (VMAF) for respective division regions of a plurality of division regions obtained by dividing a display region in which the generated two-dimensional video data is displayed, each evaluation value being obtained by numerically expressing a degradation in image quality that is caused due to encoding,
   sets quantization parameters for the respective division regions of the plurality of division regions such that the evaluation values for the respective division regions of the plurality of division regions are equal, and
   performs encoding processing on the two-dimensional video data on the basis of the set quantization parameters.
      (2) The information processing apparatus according to (1), in which
the encoding section
   calculates a difference between a maximum value and a minimum value of the evaluation values for the respective division regions of the plurality of division regions, and
   sets the quantization parameters for the respective division regions of the plurality of division regions such that the difference is less than a specified threshold.
      (3) The information processing apparatus according to (1) or (2), in which
the encoding section
   decreases the quantization parameter for the division region that is included in the plurality of division regions and for which the evaluation value is to be increased, and
   increases the quantization parameter for the division region that is included in the plurality of division regions and for which the evaluation value is to be decreased.
      (4) The information processing apparatus according to any one of (1) to (3), in which
the rendering section generates the two-dimensional video data such that a resolution of the two-dimensional video data is nonuniform in the display region in which the two-dimensional video data is displayed, and
the encoding section divides the generated two-dimensional video data into the division regions of the plurality of division regions on the basis of a distribution of the resolution of the generated two-dimensional video data.
   (5) The information processing apparatus according to (4), in which
the rendering section
   sets a region of interest and a region of non-interest in the display region in which the two-dimensional video data is displayed, the region of interest being to be rendered at a high resolution, the region of non-interest being to be rendered at a low resolution,
   renders the region of interest at a high resolution, and
   renders the region of non-interest at a low resolution, and
the encoding section
   sets a high-resolution region and a low-resolution region in the display region as the plurality of division regions on the basis of respective positions of the region of interest and the region of non-interest in the display region,
   calculates the respective evaluation values for the high-resolution region and the low-resolution region, and
   sets the respective quantization parameters for the high-resolution region and the low-resolution region such that the respective evaluation values for the high-resolution region and the low-resolution region are equal.
      (6) The information processing apparatus according to (5), in which
the encoding section
   sets, for the high-resolution region, a first quantization parameter to a fixed value, and
   sets a value of a second quantization parameter for the low-resolution region such that the evaluation value for the low-resolution region is equal to the evaluation value for the high-resolution region.
      (7) The information processing apparatus according to (6), in which
the encoding section sets the value of the second quantization parameter for the low-resolution region such that a difference between the evaluation value for the low-resolution region and the evaluation value for the high-resolution region is less than a specified threshold.
   (8) The information processing apparatus according to any one of (5) to (7), in which
the high-resolution region is the same as the region of interest, and
the low-resolution region is the same as the region of non-interest.
   (9) The information processing apparatus according to any one of (6) to (8), in which
the second quantization parameter is greater than the first quantization parameter.
   (10) The information processing apparatus according to any one of (5) to (9), in which
the rendering section sets the region of interest and the region of non-interest on the basis of the field-of-view information.
   (11) The information processing apparatus according to any one of (1) to (10), in which
the three-dimensional space data includes at least one of 360-degree-all-direction video data or space video data.
   (12) An information processing method that is performed by a computer system, the information processing method including:
performing rendering processing on three-dimensional space data on the basis of field-of-view information regarding a field of view of a user to generate two-dimensional video data depending on the field of view of the user;
calculating, as evaluation values, values of structural similarity (SSIM) for respective division regions of a plurality of division regions obtained by dividing a display region in which the generated two-dimensional video data is displayed, each evaluation value being obtained by numerically expressing a degradation in image quality that is caused due to encoding;
setting quantization parameters for the respective division regions of the plurality of division regions such that the evaluation values for the respective division regions of the plurality of division regions are equal; and
performing encoding processing on the two-dimensional video data on the basis of the set quantization parameters.
   (13) An information processing method that is performed by a computer system, the information processing method including:
performing rendering processing on three-dimensional space data on the basis of field-of-view information regarding a field of view of a user to generate two-dimensional video data depending on the field of view of the user;
calculating, as evaluation values, values of Video Multimethod Assessment Fusion (VMAF) for respective division regions of a plurality of division regions obtained by dividing a display region in which the generated two-dimensional video data is displayed, each evaluation value being obtained by numerically expressing a degradation in image quality that is caused due to encoding;
setting quantization parameters for the respective division regions of the plurality of division regions such that the evaluation values for the respective division regions of the plurality of division regions are equal; and
performing encoding processing on the two-dimensional video data on the basis of the set quantization parameters.

### REFERENCE SIGNS LIST

1 server-side rendering system
2 HMD
3 client apparatus
4 server apparatus
5 user
6 full 360-degree spherical video
8 rendering video
14 rendering section
15 encoder
19 frame image
27 reproduction section
28 renderer
29 encoder
30 controller
34 region of interest
35 region of non-interest
36 viewport (display region)
38 division region
40 high-resolution region
41 low-resolution region
60 computer

1. An information processing apparatus, comprising:
a rendering section that performs rendering processing on three-dimensional space data on a basis of field-of-view information regarding a field of view of a user to generate two-dimensional video data depending on the field of view of the user; and
an encoding section that
calculates, as evaluation values, values of structural similarity (SSIM) or values of Video Multimethod Assessment Fusion (VMAF) for respective division regions of a plurality of division regions obtained by dividing a display region in which the generated two-dimensional video data is displayed, each evaluation value being obtained by numerically expressing a degradation in image quality that is caused due to encoding,
sets quantization parameters for the respective division regions of the plurality of division regions such that the evaluation values for the respective division regions of the plurality of division regions are equal, and
performs encoding processing on the two-dimensional video data on a basis of the set quantization parameters.

2. The information processing apparatus according to claim 1, wherein
the encoding section
calculates a difference between a maximum value and a minimum value of the evaluation values for the respective division regions of the plurality of division regions, and
sets the quantization parameters for the respective division regions of the plurality of division regions such that the difference is less than a specified threshold.

3. The information processing apparatus according to claim 1, wherein
the encoding section
decreases the quantization parameter for the division region that is included in the plurality of division regions and for which the evaluation value is to be increased, and
increases the quantization parameter for the division region that is included in the plurality of division regions and for which the evaluation value is to be decreased.

4. The information processing apparatus according to claim 1, wherein
the rendering section generates the two-dimensional video data such that a resolution of the two-dimensional video data is nonuniform in the display region in which the two-dimensional video data is displayed, and
the encoding section divides the generated two-dimensional video data into the division regions of the plurality of division regions on a basis of a distribution of the resolution of the generated two-dimensional video data.

5. The information processing apparatus according to claim 4, wherein
the rendering section
sets a region of interest and a region of non-interest in the display region in which the two-dimensional video data is displayed, the region of interest being to be rendered at a high resolution, the region of non-interest being to be rendered at a low resolution,
renders the region of interest at a high resolution, and
renders the region of non-interest at a low resolution, and
the encoding section
sets a high-resolution region and a low-resolution region in the display region as the plurality of division regions on a basis of respective positions of the region of interest and the region of non-interest in the display region,
calculates the respective evaluation values for the high-resolution region and the low-resolution region, and
sets the respective quantization parameters for the high-resolution region and the low-resolution region such that the respective evaluation values for the high-resolution region and the low-resolution region are equal.

6. The information processing apparatus according to claim 5, wherein
the encoding section
sets, for the high-resolution region, a first quantization parameter to a fixed value, and
sets a value of a second quantization parameter for the low-resolution region such that the evaluation value for the low-resolution region is equal to the evaluation value for the high-resolution region.

7. The information processing apparatus according to claim 6, wherein
the encoding section sets the value of the second quantization parameter for the low-resolution region such that a difference between the evaluation value for the low-resolution region and the evaluation value for the high-resolution region is less than a specified threshold.

8. The information processing apparatus according to claim 5, wherein
the high-resolution region is the same as the region of interest, and
the low-resolution region is the same as the region of non-interest.

9. The information processing apparatus according to claim 6, wherein
the second quantization parameter is greater than the first quantization parameter.

10. The information processing apparatus according to claim 5, wherein
the rendering section sets the region of interest and the region of non-interest on the basis of the field-of-view information.

11. The information processing apparatus according to claim 1, wherein
the three-dimensional space data includes at least one of 360-degree-all-direction video data or space video data.

12. An information processing method that is performed by a computer system, the information processing method comprising:
performing rendering processing on three-dimensional space data on a basis of field-of-view information regarding a field of view of a user to generate two-dimensional video data depending on the field of view of the user;
calculating, as evaluation values, values of structural similarity (SSIM) for respective division regions of a plurality of division regions obtained by dividing a display region in which the generated two-dimensional video data is displayed, each evaluation value being obtained by numerically expressing a degradation in image quality that is caused due to encoding;
setting quantization parameters for the respective division regions of the plurality of division regions such that the evaluation values for the respective division regions of the plurality of division regions are equal; and
performing encoding processing on the two-dimensional video data on a basis of the set quantization parameters.

13. An information processing method that is performed by a computer system, the information processing method comprising:
performing rendering processing on three-dimensional space data on a basis of field-of-view information regarding a field of view of a user to generate two-dimensional video data depending on the field of view of the user;
calculating, as evaluation values, values of Video Multimethod Assessment Fusion (VMAF) for respective division regions of a plurality of division regions obtained by dividing a display region in which the generated two-dimensional video data is displayed, each evaluation value being obtained by numerically expressing a degradation in image quality that is caused due to encoding;
setting quantization parameters for the respective division regions of the plurality of division regions such that the evaluation values for the respective division regions of the plurality of division regions are equal; and
performing encoding processing on the two-dimensional video data on a basis of the set quantization parameters.
